(19) United States
(12) Patent Application Publication
(10) Pub. No.: US 2026/0022771 A1
(43) Pub. Date: Jan. 22, 2026

(54) SEALING ASSEMBLY FOR VEHICLE DISC BRAKE APPARATUS

(71) Applicant: HL MANDO CORPORATION, Pyeongtaek-si (KR)

(72) Inventors: Prakash Sunke, Novi, MI (US); Suresh Koduri, Novi, MI (US)

(21) Appl. No.: 18/777,217

(22) Filed: Jul. 18, 2024

(51) Int. Cl. F16J 15/52; F16D 65/00; F16D 125/08

(52) U.S. Cl. CPC F16J 15/52; F16D 65/0068; F16D 2125/08

(57) ABSTRACT

A sealing assembly for a vehicle disc brake apparatus is provided. The vehicle disc brake apparatus includes a caliper and a brake pad assembly movably coupled to the caliper. The sealing assembly includes a brake pad footing having an outer peripheral wall with a brake pad footing groove therein, and a boot seal attached to the brake pad footing via the brake pad footing groove. The boot seal includes an inner peripheral edge portion and an outer peripheral edge portion. The inner peripheral edge portion is received in the brake pad footing groove of the brake pad footing. The brake pad footing is secured to the brake pad assembly and the outer peripheral edge portion of the boot seal is secured to the caliper. The boot seal is extensible between a collapsed configuration and an extended configuration responsive to movement of the brake pad assembly.

### FIELD OF THE INVENTION

The present inventive concept relates generally to vehicle brakes and, more particularly, to vehicle disc brakes.

### BACKGROUND OF THE INVENTION

An electro-mechanical brake (EMB) system provides braking of a vehicle via a motor which becomes selectively energized in response to a signal from an electronic control unit (ECU) or a sensed depression of a vehicle brake pedal. An EMB system typically includes a rotor that is connected to a vehicle wheel, a brake caliper, and two or more brake pads, such as an inboard brake pad and an outboard brake pad, on opposing sides of the rotor. The brake caliper supports the brake pads and is slidably supported to an anchor bracket fixed to a non-rotatable component of the vehicle. The brake pads are connected to one or more electrically actuated devices for movement between a non-braking position and a braking position where the brake pads are moved into frictional engagement with the rotor.

FIG. 1A is a cross-sectional view of an example EMB assembly 10 for a vehicle wheel (not shown). The EMB assembly 10 includes a caliper 12 connected to any non-rotating or non-moving part of the vehicle and inboard and outboard brake pad assemblies 16a, 16b provided in the caliper 12. When the vehicle is in motion, a rotor 14 rotates with the vehicle wheel about an axle of the vehicle. Inboard brake pad assembly 16a includes an inboard brake pad 18 mounted to a backing plate 22 on an inboard side of the rotor 14, and outboard brake pad assembly 16b includes an outboard brake pad 20 mounted to a backing plate 24 on an outboard side of the rotor 14, which is opposite to the inboard side of the rotor 14. A brake pad footing 30 is engaged with the backing plate 22 of the inboard brake pad assembly 16a. A rotary screw mechanism 40 is operatively associated with the brake pad footing 30 and includes a fixed portion 42 and a translatable portion 44 threadingly associated with the fixed portion 42. The translatable portion 44 is engaged with the brake pad footing 30 and is configured to move the brake pad footing 30 back and forth relative to the rotor 14. For example, when a motor (not shown) becomes energized in response to a “brake apply” signal, the motor causes the rotary screw mechanism 40 to move the translatable portion 44 (in a linear manner) to move the brake pad footing 30 and inboard brake pad assembly 16a toward the rotor 14. Similarly, when the motor becomes energized in response to a “brake release” signal, the motor causes the rotary screw mechanism 40 to move the translatable portion 44 (in a linear manner) to move the brake pad footing 30 and inboard brake pad assembly 16a away from the rotor 14. However, the mechanism of the EMB assembly 10 is not limited to the descriptions above. For example, the movement of the rotary screw mechanism 40 in response to the “brake release” may be caused by an elastic force of a collapsible and extensible device, such as a spring.

A boot seal 50 is connected between the caliper 12 and the brake pad footing 30 as illustrated in FIGS. 1A-1B. An inner peripheral edge portion 50a (FIG. 1B) of the boot seal 50 is inserted within a brake pad footing groove 30g formed within the brake pad footing 30, and an outer peripheral edge portion 50b (FIG. 1B) of the boot seal 50 is attached to a caliper groove 12g formed within the caliper 12. The brake pad footing groove 30g may have an annular shape. The caliper groove 12g may be referred to as a caliper slot 12g. Typically, a lubricant, such as grease, is utilized to insert the inner peripheral edge portion 50a of the boot seal 50 within the brake pad footing groove 30g in the brake pad footing 30. The boot seal 50 is extensible from a collapsed configuration (FIG. 1A) to an extended configuration (FIG. 1C) as the inboard brake pad assembly 16a is moved toward and away from the rotor 14 during braking operations. The boot seal 50 is configured to seal the space between the brake pad footing 30 and the caliper 12 from foreign material, such as dust, solids, liquids, grease, water, oil, and dirt, etc., that may be detrimental to the normal functioning of the brake system (e.g., the EMB assembly 10), and which could lead to safety concerns. Herein, the foreign material may also be referred to as debris D.

As illustrated in FIGS. 2-3, there is a potential for debris D, such as snow, mud, etc., to accumulate on the boot seal 50. Unfortunately, the weight of debris D accumulated on the boot seal 50 may cause the inner peripheral edge portion 50a of the boot seal 50 to slip out of the brake pad footing groove 30g after a period of time, and particularly when the inboard and/or outboard brake pads 18, 20 are worn. Moreover, the presence of grease at the interface of the inner peripheral edge portion 50a of the boot seal 50 and the brake pad footing groove 30g in the brake pad footing 30 may exacerbate the potential for the inner peripheral edge portion 50a of the boot seal 50 to slip out of the brake pad footing groove 30g.

### SUMMARY OF THE INVENTION

A sealing assembly for a vehicle disc brake apparatus is provided. The vehicle disc brake apparatus includes a caliper and a brake pad assembly that is movably coupled to the caliper. The sealing assembly includes a brake pad footing having an outer peripheral wall with a brake pad footing groove (e.g., an annular groove) formed therein, and a boot seal attached to the brake pad footing via the brake pad footing groove. The boot seal includes an inner peripheral edge portion and an outer peripheral edge portion that is radially spaced apart from the inner peripheral edge portion. The inner peripheral edge portion is received with a snap fit in the brake pad footing groove of the brake pad footing. The brake pad footing is configured to be secured to the brake pad assembly, and the outer peripheral edge portion of the boot seal is configured to be secured to the caliper. The boot seal is formed from a resilient material and is extensible between a collapsed configuration and an extended configuration responsive to movement of the brake pad assembly.

In some embodiments, a portion of the boot seal between the inner peripheral edge portion and the outer peripheral edge portion includes a bellows section that allows the boot seal to move between a collapsed configuration and an extended configuration.

In some embodiments, at least one edge portion of the brake pad footing groove is configured to retain the inner peripheral edge portion of the boot seal within the brake pad footing groove. For example, at least one of the edge portions of the brake pad footing groove may extend toward the opposite edge portion of the brake pad footing groove. The inner peripheral edge portion of the boot seal may include a bead (e.g., at least a partially circumferential bead) that is configured to be retained within the brake pad footing groove by the edge portion of the brake pad footing groove that extends toward the opposite edge portion of the brake pad footing groove.

In some embodiments, the bead has a cross-section with a radially extending shoulder portion, and the brake pad footing groove edge portion that extends toward the opposite edge portion is configured to engage the shoulder portion when the bead is within the brake pad footing groove.

In some embodiments, both of the edge portions of the brake pad footing groove are configured to retain the inner peripheral edge portion of the boot seal within the brake pad footing groove. For example, the edge portions of the brake pad footing groove may extend toward each other, and the inner peripheral edge portion of the boot seal may include a bead that is retained within the brake pad footing groove by the edge portions of the brake pad footing groove.

In some embodiments, the bead has a cross-section with opposing radially extending shoulder portions, and the brake pad footing groove opposite edge portions are configured to engage the shoulder portions when the bead is within the brake pad footing groove. In some embodiments, the cross section of the bead is substantially semicircular (e.g., at least partially circular) and the cross section of the brake pad footing groove is substantially semicircular (e.g., at least partially circular) and sized to matingly receive the bead therein.

In some embodiments, the brake pad footing is disc-shaped, and the boot seal has an annular (at least a partially annual) configuration such that the boot seal is concentrically attached to the brake pad footing.

According to some embodiments of the present inventive concept, a vehicle disc brake apparatus includes a caliper, a brake pad assembly movably coupled to the caliper, and a sealing assembly. The sealing assembly includes a brake pad footing secured to the brake pad assembly and a boot seal attached to the brake pad footing. The brake pad footing includes an outer peripheral wall with a brake pad footing groove (e.g., an annular groove) formed therein. The boot seal includes an inner peripheral edge portion and an outer peripheral edge portion. The inner peripheral edge portion is received with a snap fit in the brake pad footing groove of the brake pad footing, and the outer peripheral edge portion of the boot seal is secured to the caliper. The boot seal is formed from a resilient material and is extensible between a collapsed configuration and an extended configuration responsive to movement of the brake pad assembly.

In some embodiments, a portion of the boot seal between the inner peripheral edge portion and the outer peripheral edge portion includes a bellows section that allows the boot seal to move between a collapsed configuration and an extended configuration.

In some embodiments, at least one edge portion of the brake pad footing groove is configured to retain the inner peripheral edge portion within the brake pad footing groove. For example, at least one of the edge portions of the brake pad footing groove may extend toward the opposite edge portion of the brake pad footing groove. The inner peripheral edge portion of the boot seal may include a bead that is retained within the brake pad footing groove by the edge portion of the brake pad footing groove that extends toward the opposite edge portion.

In some embodiments, the bead has a cross-section with a radially extending shoulder, and the brake pad footing groove edge portion that extends toward the opposite edge portion is configured to engage the shoulder portion when the bead is within the brake pad footing groove.

In some embodiments, both of the edge portions of the brake pad footing groove are configured to retain the inner peripheral edge portion within the brake pad footing groove. For example, the edge portions of the brake pad footing groove may extend toward each other, and the inner peripheral edge portion of the boot seal may include a bead that is retained within the brake pad footing groove by the edge portions of the brake pad footing groove.

In some embodiments, the bead has a cross-section with opposing radially extending shoulder portions, and the brake pad footing groove opposite edge portions are configured to engage the shoulder portions when the bead is within the brake pad footing groove. In some embodiments, the cross section of the bead is substantially semicircular (e.g., at least partially circular) and the cross section of the brake pad footing groove is substantially semicircular (e.g., at least partially circular) and sized to matingly receive the bead therein.

It is noted that aspects of the present inventive concept described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present inventive concept are explained in detail below.

### BRIEF DESCRIPTION OF THE DRAWINGS

The accompanying drawings, which form a part of the specification, illustrate various embodiments of the present inventive concept. The drawings and description together serve to fully explain embodiments of the present inventive concept.

FIG. 1A is a cross-sectional view of an EMB assembly for a vehicle wheel that illustrates a brake pad footing and a conventional boot seal attached to the brake pad footing.

FIG. 1B is a partially enlarged view illustrating region “A” of FIG. 1A.

FIG. 1C illustrates the EMB assembly of FIG. 1A with the boot seal in an extended configuration.

FIG. 2 is a plan view of the EMB assembly of FIG. 1A that illustrates debris accumulated on the boot seal.

FIG. 3 is a partially enlarged cross-sectional view of the EMB assembly of FIG. 2 that illustrates the debris accumulation on the boot seal.

FIG. 4A is a perspective view of a sealing assembly, according to embodiments of the present inventive concept.

FIG. 4B is a cutaway view of the sealing assembly of FIG. 4A.

FIG. 5 is a partially enlarged view illustrating region “B” of FIG. 4B.

FIG. 6A is a perspective view of the brake pad footing of the sealing assembly of FIG. 4A with the boot seal removed for clarity.

FIG. 6B is a cutaway view of the brake pad footing of FIG. 6A.

FIG. 7 is a partially enlarged view illustrating region “C” of FIG. 6B.

FIG. 8A is a perspective view of the boot seal of the sealing assembly of FIG. 4A with the brake pad footing removed for clarity.

FIG. 8B is a cutaway view of the boot seal of FIG. 8A.

FIG. 9 is a partially enlarged view illustrating region “D” of FIG. 8B.

FIG. 10 is a cross-sectional view of an EMB assembly with the sealing assembly of FIG. 4A installed therein.

FIG. 11 is a partially enlarged view illustrating region “E” of FIG. 10.

FIG. 12 illustrates the EMB assembly of FIG. 10 with the inboard brake pad assembly moved toward the rotor and such that the boot seal of the sealing assembly is in an extended configuration.

FIG. 13 is a partially enlarged view illustrating region “F” of FIG. 12.

FIGS. 14A-14B are cross-sectional views of a bead at a boot seal inner peripheral edge portion and a brake pad footing groove receiving the bead therein, according to some alternative embodiments.

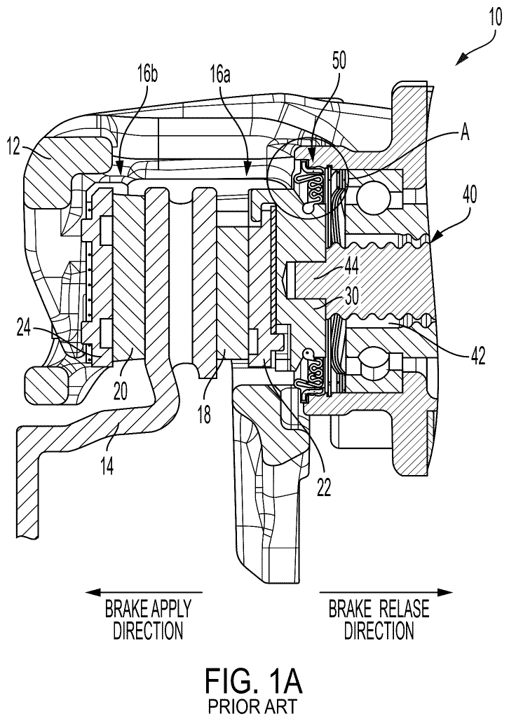

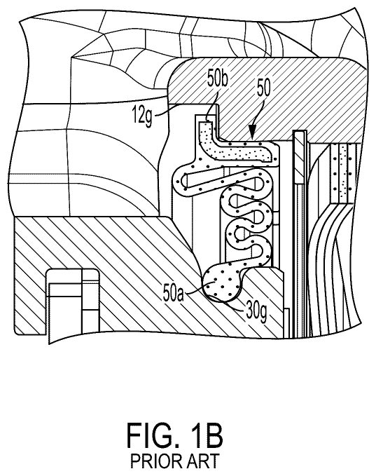

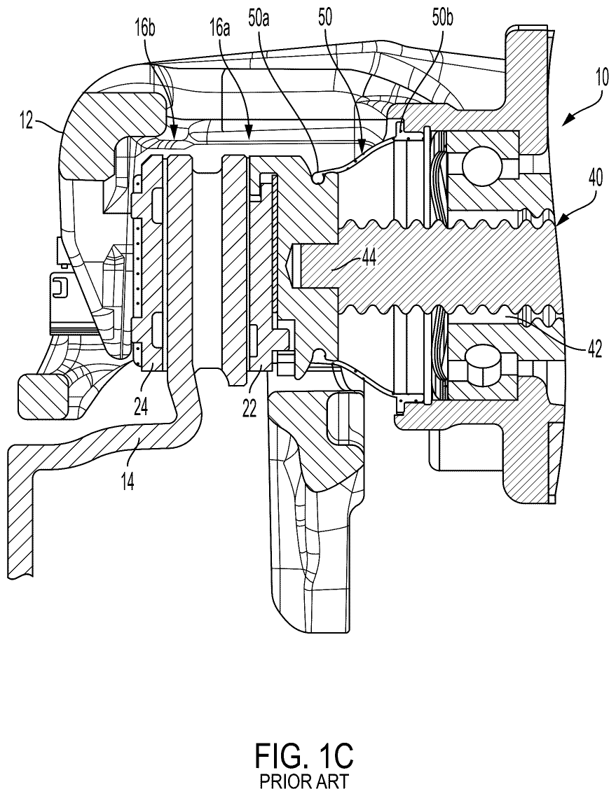

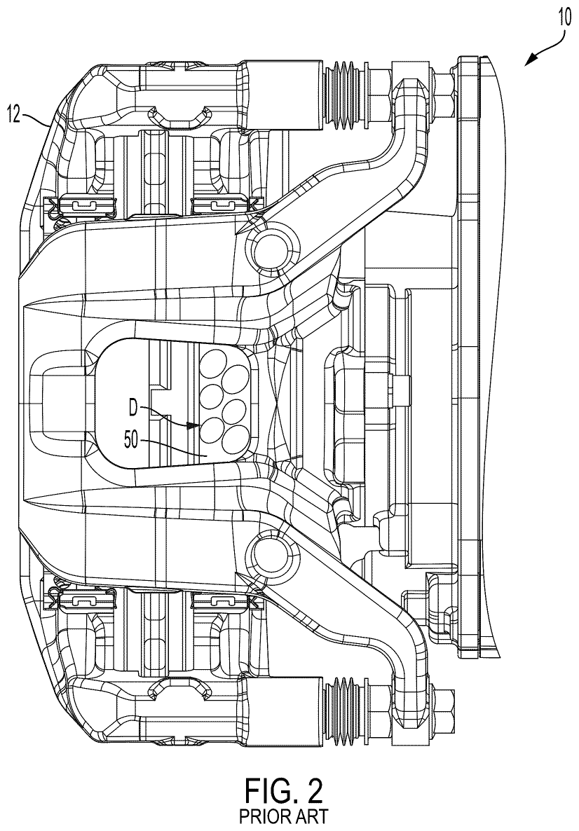

### DETAILED DESCRIPTION

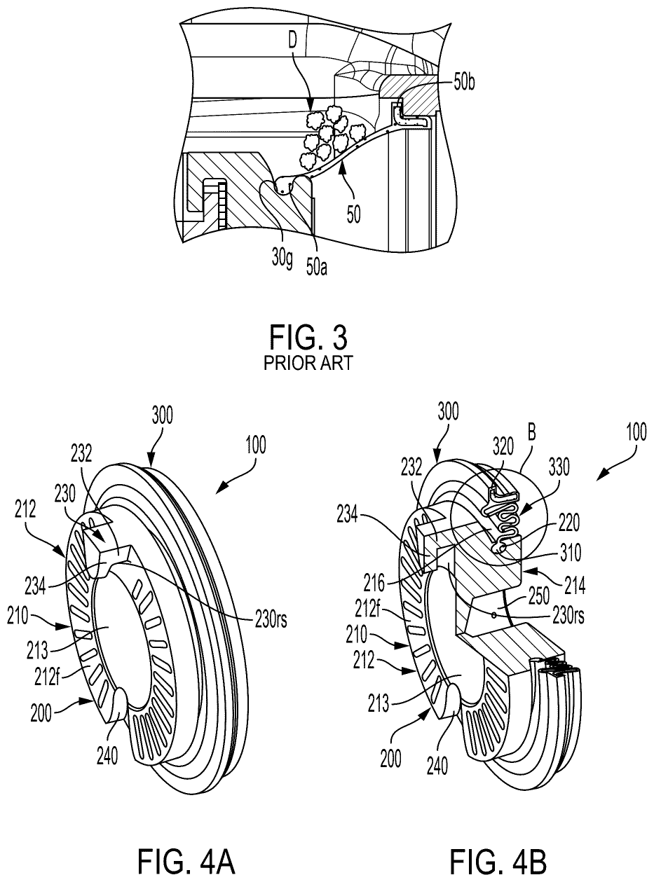

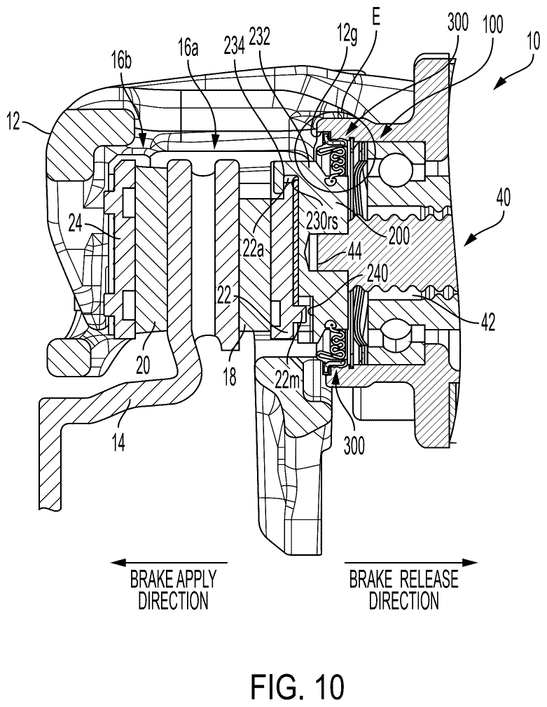

Referring to FIGS. 4A-4B, a sealing assembly 100 for a vehicle disc brake apparatus, such as an EMB assembly 10 (FIG. 10), according to some embodiments of the present inventive concept, is illustrated. The sealing assembly 100 includes a brake pad footing 200 and a boot seal 300 attached to the brake pad footing 200. The boot seal 300 is configured to seal a space between the brake pad footing 200 and the caliper 12 of the EMB assembly 10 from foreign material (e.g., the debris D), such as dust, solids, liquids, grease, water, oil, dirt, etc., that may be detrimental to the normal functioning of the EMB assembly 10.

The brake pad footing 200 is illustrated in detail in FIGS. 6A-6B and includes a body 210 having a “disc” shape with opposite first and second side portions 212, 214. The first side portion 212 of the body 210 has an outer peripheral wall 212w and the second side portion 214 of the body 210 has an outer peripheral wall 214w, as illustrated in FIGS. 6A-6B. A diameter of the outer peripheral wall 212w of the first side portion 212 is greater than a diameter of the outer peripheral wall 214w of the second side portion 214 in the illustrated embodiment. However, embodiments of the present inventive concept are not limited to the outer peripheral wall 212w of the first side portion 212 and the outer peripheral wall 214w of the second side portion 214 having different diameters. A sloped wall 216 extends between the outer peripheral wall 212w of the first side portion 212 and the outer peripheral wall 214w of the second side portion 214, as illustrated in FIG. 6B. The outer peripheral wall 214w of the second side portion 214 includes a brake pad footing groove 220 formed therein, as will be described below. The brake pad footing groove 220 may have an annular shape and be referred to as an annular groove 220.

The first side portion 212 of the body 210 has a peripheral surface portion 212f that is configured to directly or indirectly contact the backing plate 22 of the inboard brake pad 18, as illustrated in FIG. 10. For example, the peripheral surface portion 212f may contact the backing plate 22 (FIG. 10) directly or may contact a shim or other component located between the brake pad footing 200 and the backing plate 22. In the illustrated embodiment, the peripheral surface portion 212f is raised relative to the remaining surface 213 of the first side portion 212, i.e., the peripheral surface portion 212f extends outwardly further than the remaining surface 213 of the first side portion 212. The peripheral surface portion 212f is configured to apply uniform pressure to the backing plate 22 during a braking operation.

The first side portion 212 of the body 210 also includes a backing plate retaining member 230 extending outward therefrom, as illustrated in FIGS. 6A-6B. The backing plate retaining member 230 has an L-shaped configuration and includes a first portion 232 extending outward from the peripheral surface portion 212f of the first side portion 212 of the body 210 and a second portion 234 extending from the first portion 232 and generally parallel with the peripheral surface portion 212f, as illustrated. The backing plate retaining member 230 defines a receiving space 230rs that is configured to receive a portion 22a of the backing plate 22 of the inboard brake pad assembly 16a between the second portion 234 thereof and the peripheral surface portion 212f, as illustrated in FIG. 10.

The first side portion 212 of the body 210 also includes a slot 240 formed therein at a location diametrically opposite (e.g., substantially opposite) to the location of the backing plate retaining member 230, as illustrated in FIGS. 6A-6B. The slot 240 is configured to receive a member 22m protruding from the backing plate 22, as illustrated in FIG. 10. When the member 22m protruding from the backing plate 22 is engaged with the slot 240 in the first side portion 212 of the body 210, the brake pad footing 200 is properly positioned to provide uniform pressure to the backing plate 22 during a braking operation. In addition, when the member 22m protruding from the backing plate 22 is engaged with the slot 240 in the first side portion 212 of the body 210, the brake pad footing 200 can be restrained from unintended movement, such as rotational movement.

The second side portion 214 of the body 210 has a (substantially) flat surface 214f and includes a passageway 250 formed therein at a central location thereof, as illustrated in FIG. 6B. The passageway 250 is configured to receive and couple with a translatable portion 44 (FIG. 10) of a rotary screw mechanism 40 (FIG. 10). The rotary screw mechanism 40 is configured to convert rotary motion of a rotatable part of the rotary screw mechanism 40 into linear motion of the brake pad footing 200 to move the inboard brake pad assembly 16a between its brake apply and brake release positions. When a motor (not shown) becomes energized in response to a “brake apply” signal, the motor causes the rotary screw mechanism 40 to operate such that the translatable portion 44 moves the brake pad footing 200 and the inboard brake pad assembly 16a toward the rotor 14. Similarly, when the motor becomes energized in response to a “brake release” signal, the motor causes the rotary screw mechanism 40 to move the brake pad footing 200 and the inboard brake pad assembly 16a away from the rotor 14. However, the mechanisms of the “brake apply” and the “brake release” are not limited to the descriptions above. For example, the movement of the rotary screw mechanism 40 in response to the “brake release” may be caused by an elastic force of a collapsible and extensible device, such as a spring.

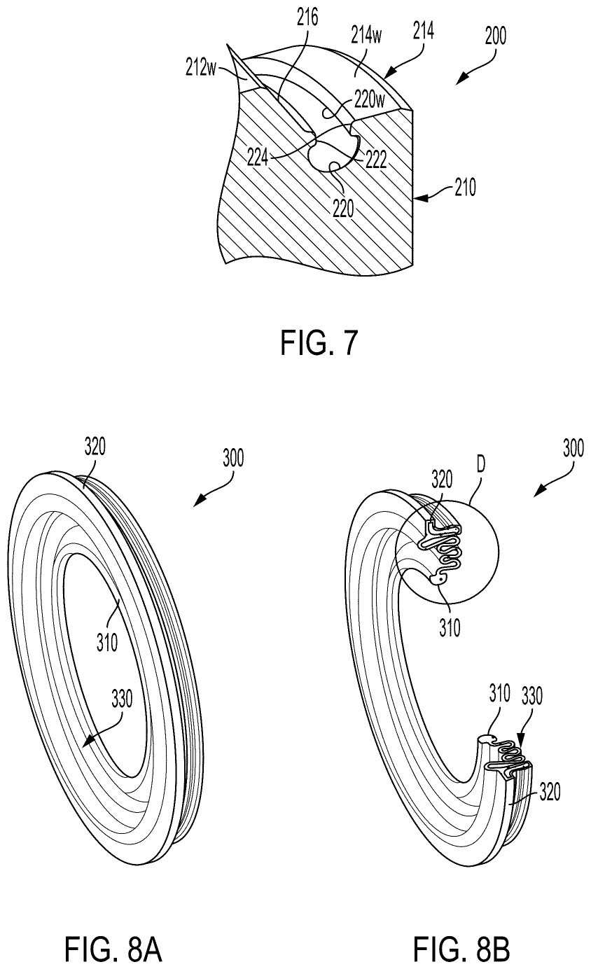

Referring to FIG. 7, the brake pad footing groove 220 in the outer peripheral wall 214w of the second side portion 214 of the body 210 includes opposite edge portions 222, 224 adjacent to the open end or entrance of the brake pad footing groove 220. The opposite edge portions 222, 224 may include a first opposite edge portion 222 and a second opposite edge portion 224. In the illustrated embodiment, the opposite edge portions 222, 224 of the brake pad footing groove 220 extend toward each other and, thus, overhang or extend over the brake pad footing groove 220. However, the embodiments of the opposite edge portions 222, 224 are not limited thereto. For example, only the first opposite edge portion 222 may extend toward the second opposite edge portion 224. This protruding configuration of the opposite edge portions 222, 224 of the brake pad footing groove 220 at the entrance to the brake pad footing groove 220 helps retain the inner peripheral edge portion 310 of the boot seal 300 within the brake pad footing groove 220 and helps prevent the boot seal 300 from becoming unintentionally disengaged from the brake pad footing 200, as will be described further below. Embodiments of the present inventive concept are not limited to the illustrated configuration of the brake pad footing groove 220, however. For example, in other embodiments, a single one of the opposite edge portions 222, 224 of the brake pad footing groove 220 may be configured to retain the inner peripheral edge portion 310 of the boot seal 300 within the brake pad footing groove 220. Moreover, the opposite edge portions 222, 224 of the brake pad footing groove 220 may have various configurations.

Although the illustrated brake pad footing 200 has a disc-shaped configuration, it is understood that other configurations are possible in accordance with embodiments of the present inventive concept. The brake pad footing 200 can have various other shapes such as an oval shape or a polygonal shape. In some embodiments, the brake pad footing 200 can be made as a single piece, such as by molding, forging, punching, spinning or casting, as well as other suitable methods for fabricating parts of the desired complexity from selected material/materials.

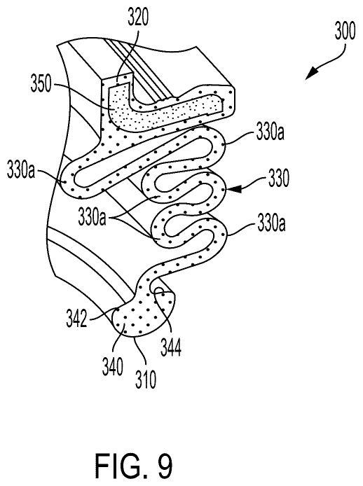

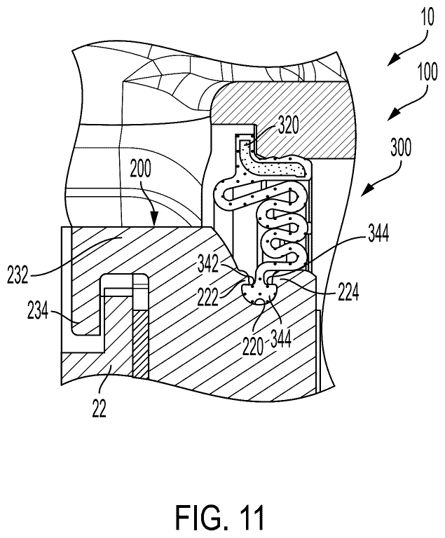

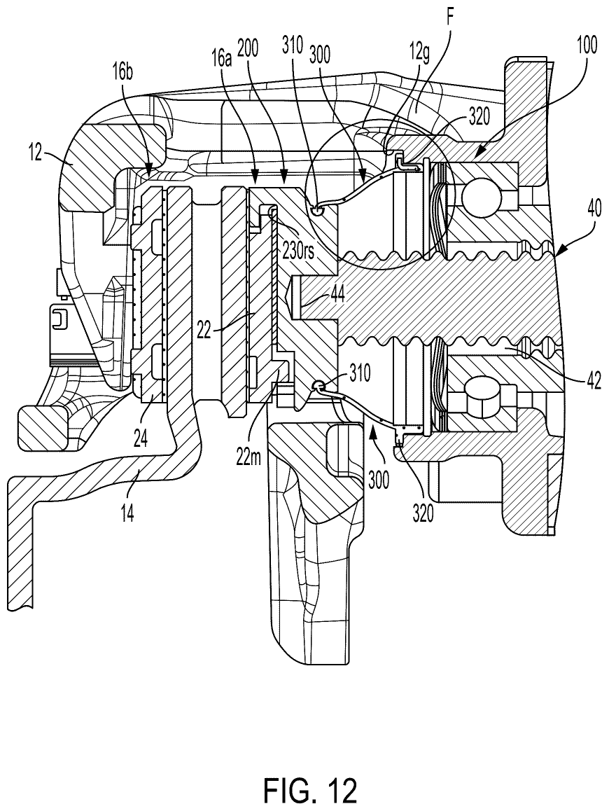

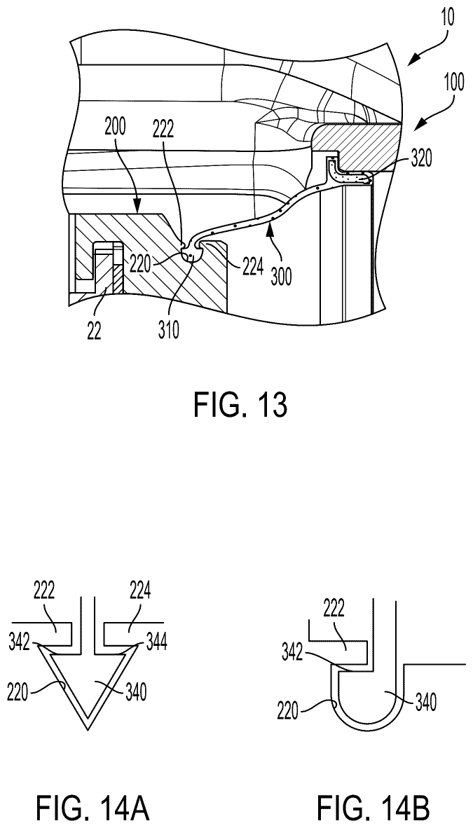

Referring to FIGS. 8A-8B and 9, the boot seal 300 of the sealing assembly 100 will now be described. The illustrated boot seal 300 has an annular configuration with an inner peripheral edge portion 310 and an outer peripheral edge portion 320 that is radially spaced apart from the inner peripheral edge portion 310. A portion of the boot seal 300 between the inner peripheral edge portion 310 and the outer peripheral edge portion 320 is a bellows section 330 that allows the boot seal 300 to move between a collapsed configuration (FIGS. 10-11) and an extended configuration (FIGS. 12-13) responsive to the linear movement of the brake pad footing 200 during braking operations. In the illustrated embodiment, the bellows section 330 includes multiple convolutions 330a that are formed with a degree of flexibility that permits the boot seal 300 to move between collapsed and extended configurations. However, embodiments of the present inventive concept are not limited to the illustrated configuration of the bellows section 330. The bellows section 330 can have various numbers of convolutions 330a, including a single convolution 330a. Moreover, the convolutions 330a of the bellows section 330 can have various configurations other than those illustrated. The boot seal 300 may be unitarily formed from a suitable elastomeric material, such as silicone rubber. However, other resilient materials may be utilized.

The inner peripheral edge portion 310 of the boot seal 300 is configured to be secured within the brake pad footing groove 220 in the outer peripheral wall 214w of the second side portion 214 of the body 210 of the brake pad footing 200 such that the boot seal 300 is concentrically attached to the brake pad footing 200, as illustrated in FIGS. 4A-4B. The outer peripheral edge portion 320 of the boot seal 300 is configured to be secured to the caliper 12 of a brake assembly 10 (e.g., the EMB assembly 10) via a caliper groove 12g, as illustrated in FIGS. 10-12. The outer peripheral edge portion 320 of the boot seal 300 includes a rigid support member 350 embedded therewithin, as illustrated in FIG. 9. The rigid support member 350 is configured to retain the outer peripheral edge portion 320 of the boot seal 300 within the caliper groove 12g of the caliper 12.

In FIGS. 10-11, the inboard brake pad assembly 16a is retracted from the rotor 14, for example by the rotary screw mechanism 40 (linearly) retracting the brake pad footing 200 when a braking operation is over, and the boot seal 300 is in a collapsed configuration. In FIG. 12, the inboard brake pad assembly 16a has been moved by the brake pad footing 200 such that the inboard brake pad 18 (not shown) contacts the rotor 14, for example by the rotary screw mechanism 40 (linearly) moving the brake pad footing 200 toward the rotor 14 during a braking operation, and the boot seal 300 is in an extended configuration.

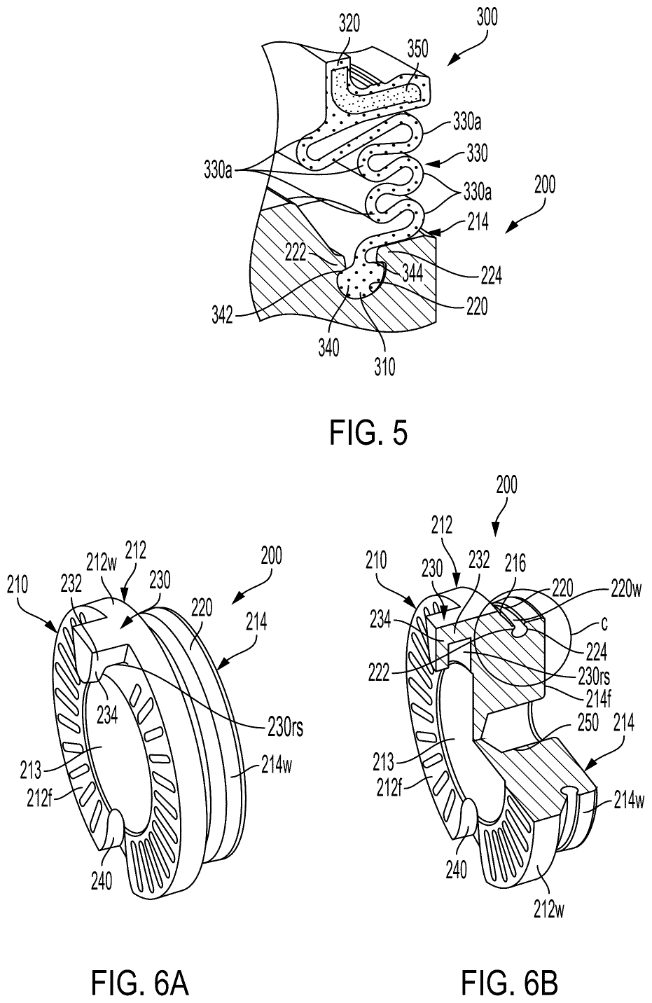

Referring back to FIG. 9, the inner peripheral edge portion 310 of the boot seal 300 includes a bead 340 of resilient material. The bead 340 may have at least a partially circumferential shape. The illustrated bead 340 has a half-round cross-section with opposing radially extending flats or shoulder portions 342, 344. Because of the resiliency of the material of the bead 340, the bead 340 can deform its shape when passing between the inward extending opposite edge portions 222, 224 of the brake pad footing groove 220. Once within the brake pad footing groove 220, the bead 340 returns to its (substantially) undeformed shape. This configuration of the brake pad footing groove 220 and the bead 340 allows the bead 340 to be received with a “snap fit” in the brake pad footing groove 220. Furthermore, once the bead 340 is inserted within the brake pad footing groove 220, the opposite edge portions 222, 224 of the brake pad footing groove 220 engage the shoulder portions 342, 344, as illustrated in FIG. 5, and retain the bead 340 within the brake pad footing groove 220 and prevent the boot seal 300 from becoming unintentionally disengaged from the brake pad footing 200. As such, the unique configuration of the brake pad footing groove 220 in the brake pad footing 200 and the unique configuration of the inner peripheral edge portion 310 of the boot seal 300 that snap fits in the brake pad footing groove 220 make it difficult for the boot seal 300 to become unintentionally disengaged from the brake pad footing groove 220 of the brake pad footing 200, even with worn brake pads 18, 20 (worn inboard and/or outboard brake pads 18, 20). Furthermore, the snap fit assembly of the boot seal 300 in the brake pad footing groove 220 provides robust sealing against foreign material, such as dust, solids, liquids, grease, water, oil, dirt, etc.

In the illustrated embodiment, the cross-section of the bead 340 is substantially half round or semicircular (e.g., at least partially circular) and the cross-section of the brake pad footing groove 220 is substantially half round or semicircular (e.g., at least partially circular) and is configured to matingly receive and engage the bead 340 therein. However, the bead 340 and the brake pad footing groove 220 can have other mating cross-sectional configurations. Embodiments of the present inventive concept are not limited to the illustrated cross-sectional configuration of the brake pad footing groove 220 or of the bead 340. Other cross-sectional configurations of the bead 340 that allows for one or more flats or shoulder portions to be engaged by one or more opposite edge portions 222, 224 of the brake pad footing groove 220 or one or more other protrusions associated with the brake pad footing groove 220 may be utilized in accordance with embodiments of the present inventive concept. For example, as illustrated in FIG. 14A, the bead 340 may have a triangular cross-section, and the brake pad footing groove 220 may have a generally triangular cross-sectional shape so as to matingly receive the bead 340 therein. The opposite edge portions 222, 224 of the brake pad footing groove 220 are configured to engage the shoulder portions 342, 344 and retain the bead 340 within the brake pad footing groove 220 and prevent the boot seal 300 from becoming unintentionally disengaged from the brake pad footing 200. As illustrated in FIG. 14B, the bead 340 may have a lop-sided, bulbous configuration, and the brake pad footing groove 220 may have a corresponding cross-sectional shape so as to matingly receive the bead 340 therein. Edge portion 222 of the brake pad footing groove 220 is configured to engage the shoulder portion 342 of the bead 340 and retain the bead 340 within the brake pad footing groove 220 and prevent the boot seal 300 from becoming unintentionally disengaged from the brake pad footing 200.

In other embodiments, only one of the brake pad footing groove 220 opposite edge portions 222, 224 may be configured to engage a shoulder portion (among the shoulder portions 342, 344) or other portion of the bead 340 and retain the bead 340 within the brake pad footing groove 220. For example, the bead 340 may have a substantially half round or semicircular cross section with only a single flat or shoulder portion. The brake pad footing groove 220 may have a correspondingly mating configuration such that only one of the brake pad footing groove opposite edge portions 222, 224 is required to receive the bead 340 therein with a snap fit and prevent unintended disengagement of the bead 340 from the brake pad footing groove 220. Moreover, the brake pad footing groove 220 may have other shapes and configurations that can serve to “latch” the boot seal 300 to the brake pad footing 200.

In other embodiments, the inner sidewall 220w of the brake pad footing groove 220 may have one or more protrusions extending outward therefrom at locations other than at the entrance to the brake pad footing groove 220 that are configured to engage one or more shoulder portions 342, 344 or other portions of the bead 340 and retain the bead 340 within the brake pad footing groove 220. Embodiments of the present inventive concept are not limited to the illustrated configuration in FIG. 7 where protrusions (e.g., the opposite edge portions 222, 224) are located at the entrance to the brake pad footing groove 220.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used herein, specify the presence of stated features, operations, elements, and/or components, but do not preclude the presence or addition of one or more other features, operations, elements, components, and/or groups thereof.

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

Aspects and elements of all of the embodiments disclosed above can be combined in any way and/or combination with aspects or elements of other embodiments to provide a plurality of additional embodiments.

1. A sealing assembly for a vehicle disc brake apparatus, the sealing assembly comprising:
a brake pad footing comprising an outer peripheral wall with a brake pad footing groove formed therein; and
a boot seal attached to the brake pad footing, the boot seal comprising an inner peripheral edge portion and an outer peripheral edge portion,
wherein the inner peripheral edge portion comprises a bead having a cross-section with one or more shoulder portions, and is received with a snap fit in the brake pad footing groove,
wherein the inner peripheral edge portion has an arcuate cross-sectional shape such that a curved portion is disposed on a bottom side of the brake pad footing groove, and
wherein the brake pad footing groove comprises one or more edge portions disposed on an entrance side of the brake pad footing groove and configured to engage the one or more shoulder portions when the bead is within the brake pad footing groove.

2. The sealing assembly of claim 1, wherein a portion of the boot seal between the inner peripheral edge portion and the outer peripheral edge portion comprises a bellows section.

3. The sealing assembly of claim 1, wherein the one or more edge portions of the brake pad footing groove comprise opposite edge portions configured to retain the inner peripheral edge portion of the boot seal within the brake pad footing groove.

4-6. (canceled)

7. The sealing assembly of claim 1, wherein the one or more shoulder portions of the bead comprise opposing shoulder portions, and wherein the one or more edge portions of the brake pad footing groove comprise opposite edge portions configured to engage the opposing shoulder portions when the bead is within the brake pad footing groove.

8. The sealing assembly of claim 7, wherein the opposite edge portions of the brake pad footing groove extend toward each other.

9. The sealing assembly of claim 1, wherein the boot seal comprises resilient material.

10. The sealing assembly of claim 1, wherein the vehicle disc brake apparatus includes a caliper and a brake pad assembly movably coupled to the caliper, wherein the brake pad footing is configured to engage the brake pad assembly, wherein the outer peripheral edge portion of the boot seal is configured to be secured to the caliper, and wherein the boot seal is extensible between a collapsed configuration and an extended configuration responsive to movement of the brake pad assembly.

11. A sealing assembly for a vehicle disc brake apparatus, the sealing assembly comprising:
a disc-shaped brake pad footing comprising an outer peripheral wall with a brake pad footing groove formed therein, wherein the brake pad footing groove comprises opposite edge portions disposed on an entrance side of the brake pad footing groove, and wherein at least one of the opposite edge portions extends toward the other edge portion; and
an annular boot seal concentrically attached to the brake pad footing, the annular boot seal comprising an inner peripheral edge portion and an outer peripheral edge portion, wherein the inner peripheral edge portion comprises a bead having a cross-section with one or more shoulder portions, and is received with a snap fit in the brake pad footing groove, and
wherein the inner peripheral edge portion has an arcuate cross-sectional shape such that a curved portion is disposed on a bottom side of the brake pad footing groove.

12. The sealing assembly of claim 11, wherein a portion of the annular boot seal between the inner peripheral edge portion and the outer peripheral edge portion comprises a bellows section.

13. The sealing assembly of claim 11, wherein the annular boot seal comprises resilient material, and wherein the bead has a semicircular cross-section with opposing radially extending shoulder portions, and wherein the at least one of the opposite edge portions of the brake pad footing groove is configured to engage at least one of the shoulder portions when the bead is within the brake pad footing groove.

14. The sealing assembly of claim 11, wherein the vehicle disc brake apparatus includes a caliper and a brake pad assembly movably coupled to the caliper, wherein the brake pad footing is configured to be secured to the brake pad assembly, wherein the outer peripheral edge portion of the annular boot seal is configured to be secured to the caliper, and wherein the annular boot seal is extensible between a collapsed configuration and an extended configuration responsive to movement of the brake pad assembly.

15. A vehicle disc brake apparatus, comprising:
a caliper;
a brake pad assembly movably coupled to the caliper; and
a sealing assembly comprising:
a brake pad footing secured to the brake pad assembly, the brake pad footing comprising an outer peripheral wall with a brake pad footing groove formed therein; and
a boot seal attached to the brake pad footing, the boot seal comprising an inner peripheral edge portion and an outer peripheral edge portion,
wherein the inner peripheral edge portion comprises a bead having a cross-section with one or more shoulder portions, and is received with a snap fit in the brake pad footing groove,
wherein the inner peripheral edge portion has an arcuate cross-sectional shape such that a curved portion is disposed on a bottom side of the brake pad footing groove,
wherein the outer peripheral edge portion is secured to the caliper, and wherein the boot seal is extensible between a collapsed configuration and an extended configuration responsive to movement of the brake pad assembly, and
wherein the brake pad footing groove comprises one or more edge portions disposed on an entrance side of the brake pad footing groove and configured to engage the one or more shoulder portions when the bead is within the brake pad footing groove.

16. The vehicle disc brake apparatus of claim 15, wherein the boot seal comprises resilient material, and wherein a portion of the boot seal between the inner peripheral edge portion and the outer peripheral edge portion comprises a bellows section.

17. The vehicle disc brake apparatus of claim 15, wherein the brake pad footing groove comprises opposite edge portions, and wherein at least one of the opposite edge portions is configured to retain the inner peripheral edge portion of the boot seal within the brake pad footing groove.

18. The vehicle disc brake apparatus of claim 15, wherein the brake pad footing groove comprises an edge portion configured to engage the one or more shoulder portions when the bead is within the brake pad footing groove.

19. The vehicle disc brake apparatus of claim 17, wherein the opposite edge portions of the brake pad footing groove extend toward each other and are configured to retain the inner peripheral edge portion of the boot seal within the brake pad footing groove.

20. A sealing assembly for a vehicle disc brake apparatus, the sealing assembly comprising:
a brake pad footing comprising an outer peripheral wall with a brake pad footing groove formed therein; and
a boot seal attached to the brake pad footing, the boot seal comprising an inner peripheral edge portion and an outer peripheral edge portion,
wherein the inner peripheral edge portion comprises a bead having a cross-section with one or more shoulder portions, and engages a surface in the annular groove such that the inner peripheral edge portion is captured in the groove,
wherein the inner peripheral edge portion has an arcuate cross-sectional shape such that a curved portion is disposed on a bottom side of the brake pad footing groove, and
wherein the brake pad footing groove comprises one or more edge portions disposed on an entrance side of the brake pad footing groove and configured to engage the one or more shoulder portions when the bead is within the brake pad footing groove.
